(19) United States
(12) Patent Application Publication
(10) Pub. No.: US 2017/0030522 A1
(43) Pub. Date: Feb. 2, 2017

(54) FILLING STATION FOR CRYOGENIC REFRIGERANT

(71) Applicant: Praxair Technology, Inc., Danbury, CT (US)

(72) Inventors: Morten Emilsen, Oslo (NO); Fedde Kielman, Zevenbergen (NL); Bent K. Andreasen, Middelfart (DK); Torgeir Hansen, Finstadjordet (NO); Lars Petter Haugland, Fjerdingby (NO)

(21) Appl. No.: 15/107,318

(22) PCT Filed: Dec. 22, 2014
(86) PCT No.: PCT/EP2014/079020

§ 371 Date: Jun. 22, 2016

(30) Foreign Application Priority Data
Dec. 23, 2013 (NO) 20131734

(51) Int. Cl. F17C 5/04; F17C 7/04

(52) U.S. Cl. CPC F17C 5/04; F17C 7/04; F17C 2205/0326; F17C 2205/0332; F17C 2205/0364; F17C 2221/013; F17C 2223/0161; F17C 2225/0161; F17C 2227/015; F17C 2227/04; F17C 2250/01; F17C 2250/043; F17C 2250/0443; F17C 2250/0439; F17C 2260/025; F17C 2265/031; F17C 2270/0168

(57) ABSTRACT

A filling station for filling a liquid cryogenic refrigerant from a supply tank to a receiver tank, the filling station comprising a flash tank between the supply tank and the receiver tank, adapted to de-pressurize the refrigerant that is transferred from the flash tank to the receiver tank, resulting in formation of a liquid cryogenic refrigerant phase and a vapour cryogenic refrigerant phase within the flash tank, and to phase separate the liquid and vapour cryogenic refrigerant phase, and a pump between the flash tank and the receiver tank, adapted for pumping the refrigerant out of the flash tank to the receiver tank, wherein the flash tank is equipped with a level control unit that is arranged to keep the level of the liquid cryogenic refrigerant phase within the flash tank at a predetermined minimum.

### FIELD OF THE INVENTION

The invention relates to a filling station adapted for filling a cryogenic refrigerant from a supply tank to a receiver tank. The filling station comprises a flash tank positioned between the supply tank and the receiver tank, this flash tank being adapted to de-pressurize the liquid cryogenic refrigerant that is transferred from the supply tank to the flash tank, resulting in the formation of a liquid cryogenic refrigerant phase and a vapour cryogenic refrigerant phase within the flash tank, and being adapted to phase separate the liquid and the vapour cryogenic refrigerant phase. The filling station furthermore comprises a pump positioned between the flash tank and the receiver tank, this pump being adapted for pumping the liquid cryogenic refrigerant out of the flash tank to the receiver tank when being in operation.

### BACKGROUND OF THE INVENTION

In the field of maintaining goods at low temperatures below environmental temperature, i.e. either frozen at −21° C. or fresh at +3° C., when being disconnected from a mains supply or a reefer, more especially during transport of these goods, several different solutions have been proposed in the prior art. Some of these comprise the use of large trucks and trailers having tanks (=transportable or mobile tanks) which are supplied with a cryogenic refrigerant, for instance liquid CO₂, as is the case in a preferred embodiment of the present invention. This cryogenic refrigerant is thus provided in a thermally insulated transportable tank mounted inside a refrigeration unit or at the chassis of the truck. Inside this refrigeration unit, the cryogenic refrigerant is evaporated in an air/refrigerant heat exchanger. The cooled air from this heat exchanger is then blown into the goods compartment of the vehicle.

In order to fill this mobile tank with liquid cryogenic refrigerant, preferably a filling station is used. An example of a filling station for filling of cryogenic refrigerant fluids, in particular liquid CO₂, from a storage tank to a mobile tank for instance located on a vehicle, is described in EP 1 463 905 in the name of Yara International ASA and Thermo King Corporation. The filling station as disclosed therein comprises the following three main components:
a storage tank into which the cryogenic refrigerant is stored;
a pressure/flow control column, also called phase separator; and
a dispenser.

These three main components are interconnected by means of liquid CO₂ piping from the storage tank to the phase separator with a branch pipe to the dispenser, and a gas pipe from the dispenser with branch pipes to the phase separator and the storage tank respectively.

Inside this pressure/flow control column, the liquid CO₂, during the filling of the mobile tank, is de-pressurized, phase separated and measured. This pressure/flow control column has a height of 5 meter and a diameter of approximately 100 mm. The pressure inside the storage tank is normally higher than in the mobile tank. Therefore, the pressure inside the column is reduced by using a back pressure regulator. The pressure reduction causes the liquid CO₂ to flash, and it produces a mixture of liquid and vapour phase inside the column. The liquid and vapour phase are then separated in a phase separator and the liquid phase going to the mobile tank is measured. The vapour phase is released to the atmosphere or may alternatively, if it is economically practical to do so, be recompressed and liquefied and put back into the storage tank. In order to allow the liquid CO₂ to flow into the mobile tank, the pressure/flow control column with the phase separator is located on a higher level than the mobile tank. The disadvantage thereof however is that the filling speed of the mobile tank is too low.

US 2011/0297273 A1 discloses a method for filling a tank with a cryogenic liquid from a storage unit during which at least part of the cryogenic liquid is transformed into gas in the tank and at least part of the gas formed is being discharged. The method includes detection of the presence of cryogenic liquid in the gas being discharged and thereby determining when the tank is full.

In order to raise the filling speed of the mobile tank, it is already known to replace the pressure/flow control column with a small flash tank serving as the phase separator that is installed between the storage tank and the mobile tank. This small flash tank has a height of 1 meter and a diameter of between 300 and 350 mm. The liquid CO₂ is brought from the flash tank into the mobile tank using a pump. This known CO₂ filling station however suffers from the disadvantage that it takes quite some time, i.e. around 1 to 2 minutes, to start filling the receiver tank.

Therefore, there exists the need to provide a filling station for filling liquid cryogenic refrigerant from a supply tank to a receiver tank, wherein the filling operation of the receiver tank is started more quickly.

### SUMMARY OF THE INVENTION

According to the invention, a filling station adapted for filling of liquid cryogenic refrigerant from a supply tank to a receiver tank is provided, the filling station comprising
a flash tank positioned between the supply tank and the receiver tank, this flash tank being adapted to
   de-pressurize the liquid cryogenic refrigerant that is transferred from the supply tank to the flash tank, resulting in the formation of a liquid cryogenic refrigerant phase and a vapour cryogenic refrigerant phase within the flash tank, and
   to phase separate the liquid and the vapour cryogenic refrigerant phase, and
a pump positioned between the flash tank and the receiver tank, this pump being adapted for pumping the liquid cryogenic refrigerant out of the flash tank to the receiver tank when being in operation,
   wherein the flash tank is equipped with a level control unit that is arranged to keep the level of the liquid cryogenic refrigerant phase within the flash tank at a predetermined minimum.

The term “at a predetermined minimum” is meant to include at or above a predetermined minimum.

In one aspect of the present invention the predetermined minimum is 10% of the size of the flash tank. The size of the flash tank is measured as the maximum mass of cryogenic refrigerant that the flash tank can contain.

In a further aspect of the present invention the predetermined minimum is 30% of the size of the flash tank.

This takes care that after connecting the filling hoses of the filling station to the receiver tank, and after a check of the pressure of the vapour phase in the receiver tank—possibly leading to an adjustment of the pressure of the vapour phase in the receiver tank—, the filling procedure of the receiver tank can start. This only takes about a maximum of ten seconds in order to start the filling the receiver tank.

The filling station according to the invention furthermore is arranged to keep the level of the flash tank below a predetermined maximum.

In one aspect of the present invention the predetermined maximum is 90% of the size of the flash tank. The size of the flash tank is as above measured as the maximum mass of cryogenic refrigerant that the flash tank can contain.

In a further aspect of the present invention the predetermined maximum is 80% of the size of the flash tank. Alternatively the predetermined maximum is in the range 80-90%.

In a favourable embodiment of a filling station according to the invention, the filling station comprises one or more exhaust ball valves adapted for blowing-off excess cryogenic refrigerant vapour out of the flash tank when the pressure in the flash tank is above a predetermined pressure limit and for blowing-off excess cryogenic refrigerant vapour out of the receiver tank when the pressure in the receiver tank exceeds a predetermined pressure limit during the filling process of the receiver tank.

The predetermined pressure limit of the flash tank is preferably between 7 and 10 bar. It is remarked that the working pressure of the flash tank is around 8 bar. When however one or more valves are opened, there is a pressure drop in the flash tank.

In an advantageous embodiment of a filling station according to the invention, the filling station comprises a silencer adapted to reduce the noise of the blowing-off of the excess vapour cryogenic refrigerant out of the flash tank and the receiver tank.

In a preferred embodiment of a filling station according to the invention, the filling station comprises cryogenic refrigerant vapour piping between the supply tank and the receiver tank, wherein the filling station comprises a liquid sensor that is located at the end of the cryogenic refrigerant vapour piping between the supply tank and the receiver tank, this liquid sensor being adapted to detect liquid cryogenic refrigerant entering the cryogenic refrigerant vapour piping when finishing the filling of the receiver tank.

In a more preferred embodiment of a filling station according to the invention, the filling station comprises a housing, wherein the liquid sensor is located inside the housing of the filling station.

In an advantageous embodiment of a filling station according to the invention, the filling station comprises purge means that are adapted to purge the cryogenic refrigerant vapour piping in order to remove liquid cryogenic refrigerant, that may have entered the cryogenic refrigerant vapour piping when finishing the filling of the receiver tank, out of the cryogenic refrigerant vapour piping.

In a more advantageous embodiment of a filling station according to the invention, the filling station comprises a gas dispenser hose, a holder for the gas dispenser hose and a controller that is arranged for receiving a signal from the holder for the gas dispenser hose and for sending a signal to the purge means, wherein at the moment the gas hose is placed on the holder after the filling of the receiver tank has ended, the holder sends a signal to the controller that at its turn sends a signal to the purge means to start the purging operation of the cryogenic refrigerant vapour piping. These purge means are especially advantageous if a high number of sequential fillings have to be performed the one directly after the other.

The purge means preferably comprise a purge valve located in the cryogenic refrigerant vapour piping between the supply tank and the receiver tank.

In a favourable embodiment of a filling station according to the invention, the filling station comprises recirculation means that are arranged for recirculating cryogenic refrigerant liquid out of the flash tank towards the pump in order to cool down the pump.

More preferably, the flash tank comprises
a bottom part that is connected to the receiver tank by means of a second cryogenic refrigerant liquid piping, wherein the pump is located in the second cryogenic refrigerant liquid piping, and
a top part that is connected to the second cryogenic refrigerant liquid piping by means of a third cryogenic refrigerant liquid piping,
   and in that the recirculation means comprise a recirculation valve located in the second cryogenic refrigerant liquid piping, this recirculation valve being adapted to recirculate cryogenic refrigerant liquid out of the bottom part of the flash tank to the pump in order to cool down the pump.

Another disadvantage of the known filling stations having a small flash tank as described above is that they are having problems with the exhaust valves causing the interruption of the filling of the mobile tank only after 10 seconds, which is undesirable because every time the filling procedure of the mobile tank has to be restarted.

There therefore exists the need to provide a filling station for filling liquid cryogenic refrigerant from a supply tank to a receiver tank, having a sufficient filling speed and constantly filling the receiver tank without interruption of the filling process of this receiver tank.

Thereto, in a favourable embodiment of a filling station according to the invention, the flash tank has a size and the pump has an outflow of liquid cryogenic refrigerant being such that the ratio between the size of the flash tank and the outflow of liquid cryogenic refrigerant out of the pump is equal to or more than 1, wherein the size of the flash tank is defined as the maximum mass of cryogenic refrigerant the flash tank can contain and the outflow of liquid cryogenic refrigerant out of the pump is measured in mass per minute.

The size of the flash tank is measured as the maximum mass of cryogenic refrigerant that the flash tank can contain. This mass is normally measured in kg which is usual for defining the size of tanks containing liquefied gas. Accordingly the maximum size of the flash tank can be expressed as the maximum weight of cryogenic refrigerant that can filled into the flash tank.

Such a filling station has an adequate filling speed and is not interrupted during the filling process of the receiver tank.

In an advantageous embodiment of a filling station according to the invention, the ratio between the size of the flash tank and the outflow of the liquid cryogenic refrigerant out of the pump is between 1 to 5.

The bigger the ratio between the size of the flash tank and the outflow of liquid cryogenic refrigerant out of the pump, the better the stability of the filling station. It is however important to notice that, for economic reasons and for reasons of limited available space for the filling station, the flash tank has to have a size such that it fits into the housing of the filling station.

In a preferred embodiment of a filling station according to the invention, the supply tank is a stationary storage tank that is under pressure between 12 bar and 20 bar.

In an advantageous embodiment of a filling station according to any the invention, the receiver tank is a mobile tank that is under pressure between 7 bar to 10 bar. This mobile tank preferably is located on a vehicle such as a truck.

The cryogenic refrigerant preferably is CO₂.

### BRIEF DESCRIPTION OF THE FIGURES

FIG. 1 shows a schematic scheme of a preferred embodiment of a CO₂ filling station for filling liquid CO₂ from a stationary storage tank to a mobile tank according to the invention.

### DETAILED DESCRIPTION OF THE INVENTION

Goods to be kept cold or frozen can be different types of products like for instance food, pharmaceutical products and biological products. Such products will typically have an expiration date, and must be kept at a specific low temperature prior to said expiration date. In order to comply with this requirement during loading from a facility, as well as shipping and transport to a destination, the products are stored in a cooled goods compartment that is cooled using cold air originating from a cryogenic refrigerant, preferably liquid CO₂ that is stored in a thermally insulated receive tank.

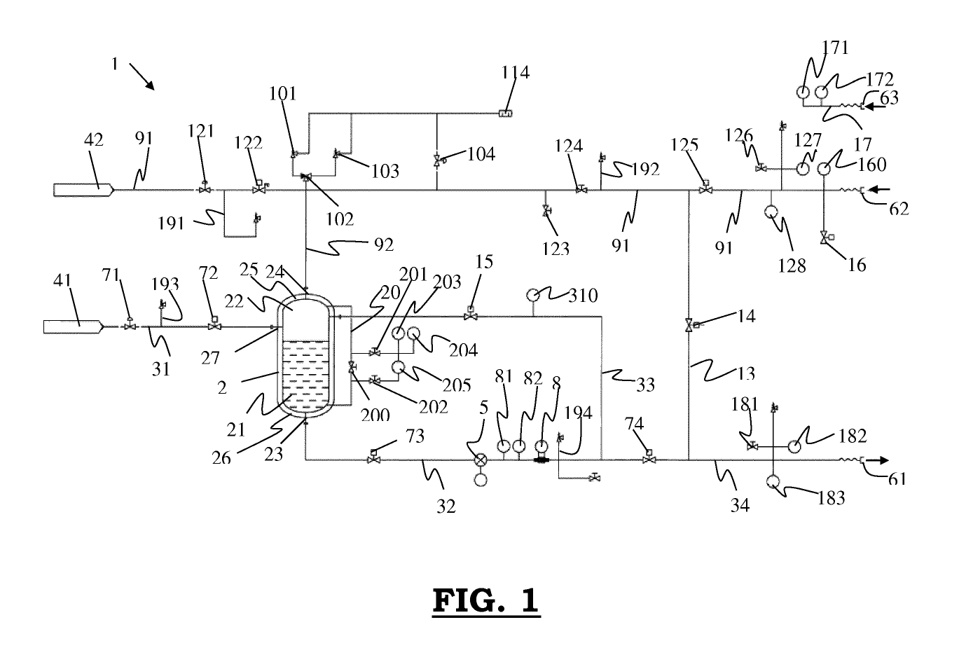

In order to fill the thermally insulated receiver tank present on the vehicle, also called the mobile tank, with liquid CO₂, a CO₂ filling station is used. A preferred embodiment of a filling station 1 for delivering liquid CO₂ as the cryogenic refrigerant to a mobile tank (not shown in the FIGURE) according to the invention is shown in FIG. 1. This filling station 1 comprises three main components, i.e.
a stationary storage tank (=supply tank) (not shown in the FIGURE) for liquid CO₂;
a flash tank 2; and
a dispenser system (not shown on the FIGURE).

The stationary storage tank is under a pressure of 12-20 bar, while the mobile tank is under a pressure of 7-10 bar. The working pressure of the mobile tank preferably is 8 bar. This pressure however drops when one or more valves of the filling station 1 are opened. In order to cope with the pressure difference between the storage tank and the mobile tank, a flash tank 2 is installed between the storage tank and the mobile tank. The flash tank 2 serves as a phase separator to de-pressurize the liquid CO₂ that is transferred from the storage liquid CO₂ tank to the mobile liquid CO₂ tank. Because of this de-pressurization, a liquid CO₂ phase 21 and a vapour (gas) CO₂ phase 22 are formed in the flash tank 2, which are phase separated in the flash tank 2. The vapour CO₂ phase 22 is substantially located in the top part 25 of the flash tank 2, while the liquid CO₂ phase 21 is substantially located in the bottom part 26 of the flash tank 2.

As can be seen on FIG. 1, the top part 25 of the flash tank 2 comprises a CO₂ vapour (gas) outlet 24 that is connected to a CO₂ gas piping 92. This CO₂ gas piping 92 is provided with three safety valves 101, 102, 103 that are arranged to automatically open when the pressure in the flash tank 2 is too high. Furthermore, this CO₂ gas piping 92 is provided with an exhaust ball valve 124 that is arranged for blowing-off excess vapour CO₂ out of the flash tank 2 when the pressure in the flash tank 2 is above a predetermined pressure limit. This predetermined pressure limit of the flash tank 2 is preferably situated between 7 and 10 bar. It is remarked that the normal working pressure within the flash tank 2 is 8 bar. This exhaust ball valve 124 preferably is an electronically steered ball valve which is more reliable because the opening and closing of the valve is always performed. At the end of the CO₂ gas piping 92, a silencer 114 is provided that is adapted to reduce the noise of the blowing-off of excess CO₂ gas out of the flash tank 2.

The dispenser system comprises three dispenser hoses (not shown on the FIGURE) that are connectable by means of quick connectors 61, 62, 63 to the mobile tank, i.e.
1. a liquid CO₂ dispenser hose that is arranged to be connected to the mobile tank by means of a first quick connector 61;
2. a CO₂ gas return hose that is arranged to be connected to the mobile tank by means of a second quick connector 62. This CO₂ gas return hose 62 is arranged to allow CO₂ gas coming out of the mobile tank to enter this return hose 62 when liquid CO₂ is being filled into the mobile tank.
3. a control hose that is arranged to be connected to the mobile tank by means of a third quick connector 63. This control hose is connected to a pressure transmitter 171 adapted to measure the pressure in the control hose and a pressure indicator 172 that is adapted to show the pressure measured with the pressure transmitter 171. This control hose ensures that the maximum design pressure of the mobile tank is not exceeded during the filling operation of the mobile tank.

Each of the quick connectors 61, 62, 63 is provided with an anti-tow away-system, meaning that, when the mobile tank of for instance a truck is full, and the driver of the truck drives away without disconnecting one or more of the hoses, the connection will break without loss of CO₂.

The dispenser system is furthermore provided with a holder (not shown on the FIGURE) that is arranged to releasably hold the three dispenser hoses as disclosed above.

The main components of the filling station 1 as listed above are interconnected by means of liquid CO₂ piping 31, 32, 33, 34 as well as CO₂ gas piping 91, 93, 94 that are provided with different valves.

Between the liquid CO₂ outlet 41 from the storage tank and the quick connector 61, liquid CO₂ piping 31, 32, 33, 34 extends.

The flash tank 2 is located between a first part 31 of the liquid CO₂ piping and a second part 32 of the liquid CO₂ piping.

The pump 5 is positioned in the second part 32 of the liquid CO₂ piping extending between the flash tank 2 and the first quick connector 61. This pump 5 is adapted for pumping the liquid CO₂ out of the bottom part of the flash tank 2 to this first quick connector 61.

Between the top part of the flash tank 2 and the second liquid CO₂ piping part 32, a third part 33 of the liquid CO₂ piping part is provided. In this third liquid CO₂ piping part 32, preferably a recirculation valve 15 is provided that is arranged to allow recirculation of liquid CO₂ from the bottom part of the flash tank 2 to the pump 5 in order to cool down the pump 5. In the second liquid CO₂ piping part 32, after the pump 5, a flow meter 8 is provided that is arranged to measure the outflow of the liquid CO₂ out of the pump 5. In order to measure correctly the amount of liquid CO₂ flowing out of the pump 5, the liquid CO₂ must be 100% liquid and also be free of gas bubbles. In order to ensure that 100% liquid CO₂ is being pumped out of the pump 5, in the second part 32 of the liquid CO2 piping, a temperature sensor 81 is provided that is arranged for measuring the temperature of the liquid CO₂ that is flowing out of the pump 5 and a pressure transmitter 82 is provided that is adapted for measuring the pressure of the liquid CO₂ pumped out of the pump 5. For instance, for a pressure of the liquid CO₂ between 8 and 10 bar, the temperature of this liquid CO₂ has to be between −40° C. and −45° C. in order to be sure that 100% liquid CO₂ is obtained. If the temperature is higher, then no 100% liquid CO₂ is pumped out of the pump 5. In the third part of the liquid CO₂ piping part 33, a temperature sensor 310 is arranged to measure the temperature of the CO₂ gas flowing through the recirculation valve 15.

As can be seen in FIG. 1, a connection piping 13 is provided that connects a fourth part 34 of the liquid CO₂ piping and the CO₂ gas-piping 91, wherein this fourth part 34 of the liquid CO₂ piping is arranged with a valve 14. This connection piping 13 with the valve 14 are adapted to bring the liquid CO₂ piping onto CO₂ gas pressure in order to avoid dry ice into the fourth part of the liquid CO₂ piping 34, for instance when the filling station 1 is being started up.

In the fourth part 34 of the liquid CO₂ piping, a safety valve 181, as well as a pressure transmitter 182 are provided, this pressure transmitter 182 being adapted to measure the pressure in the fourth part 34 of the liquid CO₂ piping and a pressure indicator 183 adapted to indicate the pressure measured by this pressure transmitter 182. On the basis of the pressure measured by this pressure transmitter 182 and read on the pressure indicator 183, it is decided whether the valve 14 in the connection piping 13 has to be opened allowing the liquid CO₂ piping to be put on the pressure of the CO₂ gas piping (also called pre-tensioning of the liquid CO₂ piping).

As can be seen in FIG. 1, between the liquid CO₂ outlet 41 of the storage tank and the inlet 27 of the flash tank 2, a first liquid CO₂ supply valve 71 is arranged allowing liquid CO₂ to pass through this first liquid CO₂ supply valve 71 when being open. Also a liquid CO₂ emergency valve 72 is provided. Between the liquid CO₂ outlet 23 of the flash tank 2 and the pump 5, a second liquid CO₂ supply valve 73 adapted for supplying liquid CO₂ to the pump 5 is provided when this second liquid CO₂ supply valve 73 is open. Between the pump 5 and the liquid delivery 61 of the mobile tank, after the place where the third part 33 of the liquid CO₂ piping intersects with the second part 32 of the liquid CO₂ piping, a third liquid CO₂ supply valve 74 is arranged that is adapted to supply liquid CO₂ to the mobile tank when being open.

Between the CO₂ gas outlet 42 from the storage tank and the CO₂ gas return hose 62 that is adapted to be connected to the mobile tank, CO₂ gas piping 91, 93 and 94 extends.

This CO₂ gas piping that extends between the CO₂ gas outlet 42 from the storage tank and the CO₂ gas return hose 62 is dividable in three parts:
a first part 91 that extends between the CO₂ gas outlet 42 from the storage tank and the interconnection of the CO₂ gas piping 92 and the CO₂ gas outlet 24 of the flash tank 2;
a second part 93 that extends between the intersection of the CO₂ gas piping 92 and the CO₂ gas outlet 24 of the flash tank 2 and the interconnection piping 13; and
a third part 94 that extend between the interconnection piping 13 and second the second quick connector 62.

The exhaust valve 104 as described above is also connected with the second part 93 of the CO₂ gas piping in order to allow blowing-off of CO₂ gas entering the second and third part 93, 94 of the CO₂ gas piping when filling the receiver tank. The silencer 114, which is already mentioned above, also takes care that the noise produced during the blowing-off of CO₂ gas while filling of the receiver tank is reduced.

Each part of the CO₂ gas piping where liquid CO₂-inclusion can occur has to be provided with an emergency valve. This is the case in the first, second and third part 91, 93 and 94 of the CO₂ gas piping. The following safety valves are arranged:
a first safety valve 122 in the first part 91 of the CO₂ gas piping;
a second safety valve 124 in the second part 93 of the CO₂ gas piping; and
a third safety valve 126 in the third part 91 of the CO₂ gas piping.

These safety valves 122, 124, 126 are closed during the normal operation of the filling station 1.

The following maintenance valves are provided in the CO₂ gas piping:
a first maintenance valve 121 in the first part 91 of the CO₂ gas piping;
a maintenance safety valve 123 in the second part 93 of the CO₂ gas piping; and
a third maintenance valve 125 in the third part 91 of the CO₂ gas piping.

At the level of the third safety valve 126, a pressure transmitter 127 and a pressure indicator 128 are provided. The pressure transmitter 127 is adapted to measure the pressure in the third part 94 of the CO₂ gas piping in order to check if there is still pressure on the pipework. The pressure indicator 128 is arranged to indicate the pressure measured by the pressure transmitter 127.

As can be seen on FIG. 1, the first and the second part 91, 93 of the CO₂ gas piping and the first and the second part 31, 32 of the liquid CO₂ piping is provided with safety flaps 191, 192, 193, 194. In normal operation of the filling station 1, these safety flaps 191, 192, 193, 194 are closed. These safety flaps 191, 192, 193, 194 are set at a certain predetermined pressure and are automatically opened when this predetermined pressure is exceeded.

At the end of the fourth part 94 of the CO₂ gas-piping, purge means, preferably in the form of a purge valve 16, are provided, this purge valve 16 being arranged to get liquid CO₂ out of the CO₂ gas piping 94, this liquid CO₂ entering the CO₂ gas piping 94 when the filling operation of the receiver tank is finished (this being the signal that the receiver tank is full). In order to detect liquid CO₂ entering the fourth part 94 of the CO₂ gas piping when finishing the filling operation of the receiver tank, a liquid sensor 160 is provided. This liquid sensor 160 is preferably located inside the housing of the filling station 1. The purging process performed by this purge valve 16 works as follows: after the receiver tank is full (or after the liquid sensor 160 detected liquid CO₂ in the fourth part 94 of the CO₂ gas piping), the liquid CO₂ filling hose will be put back by the operator on its holder. At that moment, a signal is sent to a controller (not shown on the FIGURE), resulting in the controller at its turn sending a signal to the purge valve 16 allowing the purge valve 16 to operate and to purge the CO₂ gas piping in order to remove the liquid CO₂ out of it.

The flash tank 2 has a size and the pump 5 has an outflow of liquid CO₂ being such that the ratio between the size of the flash tank 2 and the outflow of the pump is more than 1 and more preferably between 1 and 5.

### Example

Known CO₂ filling station:
Size of the flash tank that contains a maximum of 50 kg liquid CO₂
Outflow pump=55-60 kg/minute
Ratio of the size of the flash tank/outflow of the pump=1.1-1.2 minute
Filling station according to the invention
Size of the flash tank that contains a maximum of 140 kg-286 kg
Outflow pump=60-100 kg/minute
Ratio size of the flash tank/outflow pump=2.33-2.86 minute

The flash tank 2 is equipped with a level control unit 205 that is arranged to keep the level of the liquid CO₂ within the flash tank 2 above a predetermined minimum and preferably also below a predetermined maximum. In this way, the flash tank 2 is always at least partially filled, resulting in a reduced starting time of the filling process of the mobile tank. The level control unit 205 is measuring the content of the liquid CO₂ within the flash tank 2.

Between the bottom part 26 and the top part 25 of the flash tank 2, a piping 20 extends which is arranged with a valve 200. Below the valve 200 a branch line with a separate normally open valve 202 is arranged. A further branch line is arranged on the line 20 above the valve 200, this branch also comprises a normally open valve 201. The level control unit 205 is arranged between these two branch line valves 202 and 201. A pressure indicator 203 that is arranged to indicate the pressure in the flash tank 2 is connected to the level control unit 205. Further a pressure transmitter 204 is arranged to transmit the pressure or pressures measured by the level control unit 205.

1. A filling station adapted for filling a liquid cryogenic refrigerant from a supply tank to a receiver tank, the filling station comprising
a flash tank positioned between the supply tank and the receiver tank, this flash tank being adapted to
de-pressurize the liquid cryogenic refrigerant that is transferred from the supply tank to the flash tank, resulting in the formation of a liquid cryogenic refrigerant phase and a vapour cryogenic refrigerant phase within the flash tank, and
to phase separate the liquid and the vapour cryogenic refrigerant phase, and
a pump positioned between the flash tank and the receiver tank, the pump being adapted for pumping the liquid cryogenic refrigerant out of the flash tank to the receiver tank when being in operation,
wherein the flash tank is equipped with a level control unit that is arranged to keep the level of the liquid cryogenic refrigerant phase within the flash tank at a predetermined minimum.

2. The filling station according to claim 1, wherein the level control unit is arranged to keep the level of the flash tank below a predetermined maximum.

3. The filling station according to claim 1, wherein the filling station comprises one or more exhaust ball valves adapted for
blowing-off excess cryogenic refrigerant vapour out of the flash tank when the pressure in the flash tank exceeds a predetermined pressure limit; and
blowing-off excess cryogenic refrigerant vapour out of the receiver tank when the pressure in the receiver tank exceeds a predetermined pressure limit during the filling process of the receiver tank.

4. The filling station according to claim 3, wherein the predetermined pressure limit of the flash tank is between 7 and 10 bar.

5. The filling station according to claim 1, wherein the filling station comprises a silencer adapted to reduce the noise of the excess cryogenic refrigerant vapour being blown-off out of the flash tank and the receiver tank.

6. The filling station according to claim 1, wherein the filling station comprises cryogenic refrigerant vapour piping between the supply tank and the receiver tank, wherein the filling station comprises a liquid sensor that is located at the end of the cryogenic refrigerant vapour piping between the supply tank and the receiver tank, this liquid sensor being adapted to detect liquid cryogenic refrigerant entering the cryogenic refrigerant vapour piping when finishing the filling of the receiver tank.

7. The filling station according to claim 6, wherein the filling station comprises a housing, and in that the liquid sensor is located inside the housing of the filling station.

8. The filling station according to claim 1, wherein the filling station comprises purge means adapted to purge the cryogenic refrigerant vapour piping in order to remove liquid cryogenic refrigerant, that entered the cryogenic refrigerant vapour piping when finishing the filling of the receiver tank, out of the cryogenic refrigerant vapour piping.

9. The filling station according to claim 8, wherein the filling station comprises
a gas dispenser hose;
a holder for the gas dispenser hose;
a controller that is arranged for receiving a signal from the holder for the gas dispenser hose and for sending a signal to the purge means;
wherein at the moment the gas dispenser hose is placed on the holder after the filling of the receiver tank has ended, the holder sends a signal to the controller that at its turn sends a signal to the purge means to start the purging operation of the cryogenic refrigerant vapour piping.

10. The filling station according to claim 8, wherein the purge means comprise a purge valve located in the cryogenic refrigerant vapour piping between the supply tank and the receiver tank.

11. The filling station according to claim 1, wherein the filling station comprises recirculation means that are arranged for recirculating cryogenic refrigerant liquid out of the flash tank towards the pump in order to cool down the pump.

12. The filling station according to claim 11, wherein the flash tank comprises
a bottom part that is connected to the receiver tank by means of a second cryogenic refrigerant liquid piping, wherein the pump is located in the second cryogenic refrigerant vapour piping and
a top part that is connected to the second cryogenic refrigerant liquid piping by means of a third cryogenic refrigerant liquid piping,
and in that the recirculation means comprise a recirculation valve located in the second cryogenic refrigerant liquid piping, this recirculation valve being adapted to recirculate cryogenic refrigerant liquid out of the bottom part of the flash tank to the pump in order to cool down the pump.

13. The filling station according to claim 1, wherein the filling station comprises a flow meter that is located in the second cryogenic refrigerant vapour piping after the pump and that is arranged to measure the amount of liquid CO₂ that is pumped into the receiver tank.

14. The filling station according to claim 1, wherein the flash tank has a size and the pump has an outflow of liquid cryogenic refrigerant being such that the ratio between the size of the flash tank and the outflow of liquid cryogenic refrigerant out of the pump is equal to or more than 1.

15. The filling station according to claim 14, wherein the ratio between the size of the flash tank and the outflow of the liquid cryogenic refrigerant out of the pump is between 1 and 5.

16. The filling station according to claim 1, wherein the supply tank is a stationary storage tank that is under pressure between 12 bar and 20 bar.

17. The filling station according to claim 1, wherein the receiver tank is a mobile tank that is under pressure between 7 bar to 10 bar.

18. The filling station according to claim 1, wherein the cryogenic refrigerant is CO₂.
